(19) United States
(12) Patent Application Publication
(10) Pub. No.: US 2005/0100194 A1
(43) Pub. Date: May 12, 2005

(54) Device to acquire the image of a fabric on a weaving loom and quality control method making use of said device

(75) Inventors: Diego Venturini, Azzano S. Paolo Bergamo (IT); Innocente Cassader, Albino Bergamo (IT)

Correspondence Address: YOUNG & THOMPSON, 745 SOUTH 23RD STREET, 2ND FLOOR, ARLINGTON, VA, 22202, US

(73) Assignees: EUTRON S.P.A., BERGAMO (IT); PROMATECH S.P.A., BERGAMO (IT)

(21) Appl. No.: 10/984,864

(22) Filed: Nov. 10, 2004

(30) Foreign Application Priority Data
Nov. 10, 2003 (IT) RM2003A000522

(51) Int. Cl. G06K 9/00

(52) U.S. Cl. 382/111; 382/141

(57) ABSTRACT

A device to acquire images of a fabric being woven on a loom includes at least one window (5) to define the visual field, the fabric being woven moving progressively adjacent to the window, and a sensing element (2) to acquire the image of the fabric, such components being positioned at the opposite ends of an optical path, the length of which is adjustable. The invention also includes a method for the quality control of the fabric, making use of the device.

The present invention concerns a device to acquire fabric images on a weaving loom.

Recent experiments carried out in the weaving loom field have led to need of providing a system apt to acquire a digital image of the fabric as it is being woven on the loom.

The object of the present invention is to thus supply a device for image acquisition, having dimensions and a configuration suitable for its positioning on a weaving loom, as well as being fit to acquire a digital image of the fabric in any operating conditions and in a fixed reference position in respect of the loom.

Said object is reached with the device described in the accompanying main claim.

Other inventive aspects of the present invention are described in the dependent claims.

Further characteristics and advantages of the device according to the invention will anyhow be more evident from the following detailed description of a preferred embodiment thereof, given by way of example and illustrated in the accompanying drawings, in which:

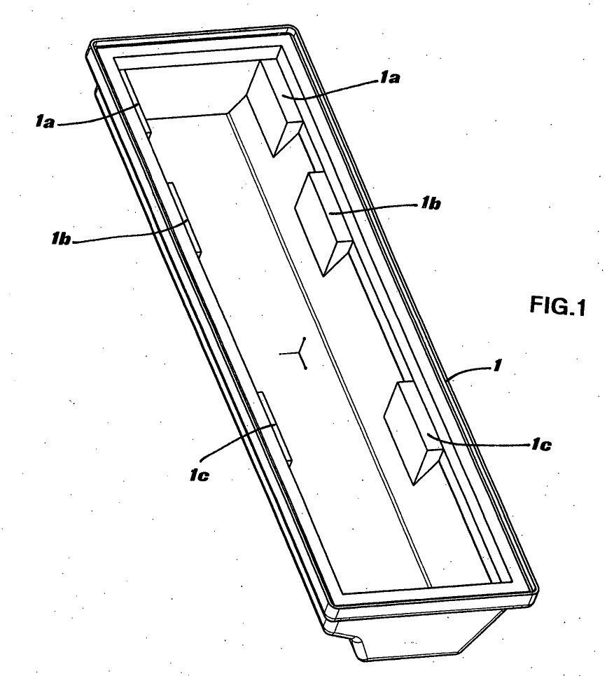

FIG. 1 is a top perspective view of a housing elongated cup within which components of the invention are accommodated;

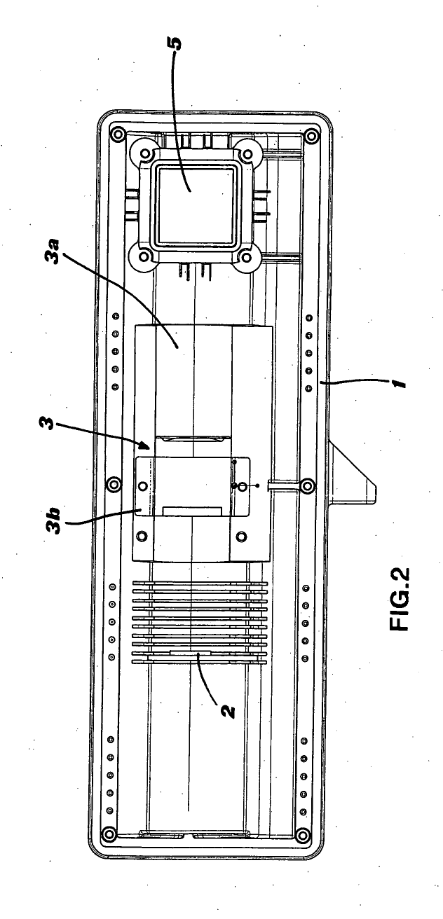

FIG. 2 is a top plan look-through view of the whole device of the invention, with removed cover;

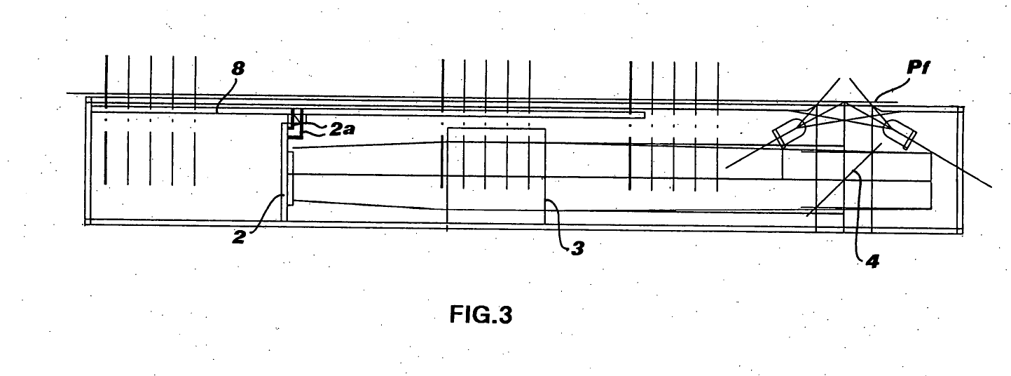

FIG. 3 is a diagrammatic longitudinal section view illustrating the optical path in the device of the invention;

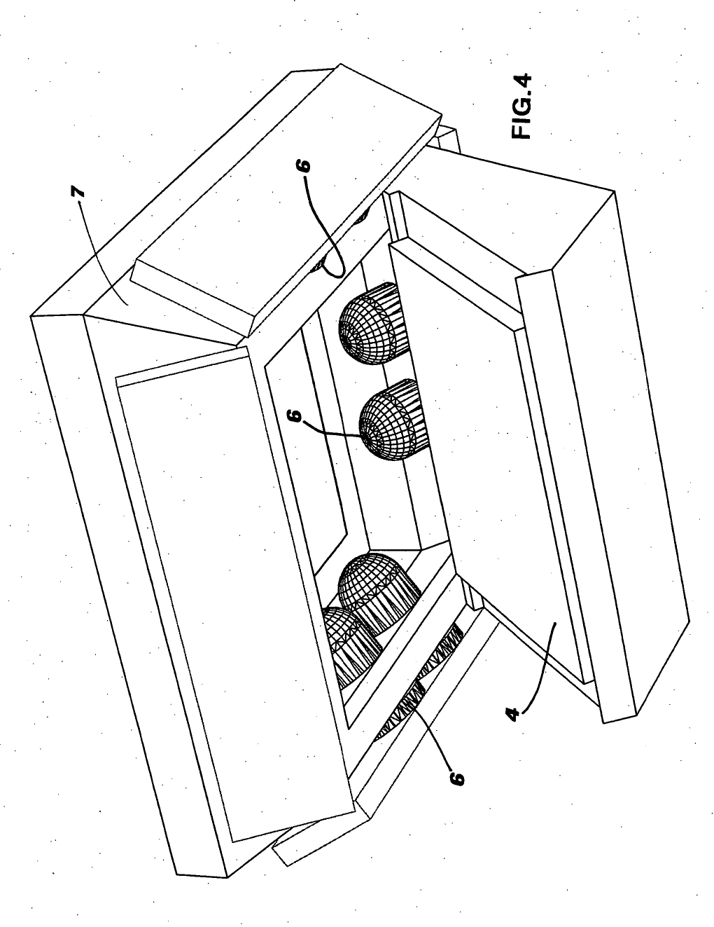

FIG. 4 is a diagrammatic perspective view, on an enlarged scale, of the LED lighting means of the device according to the invention; and

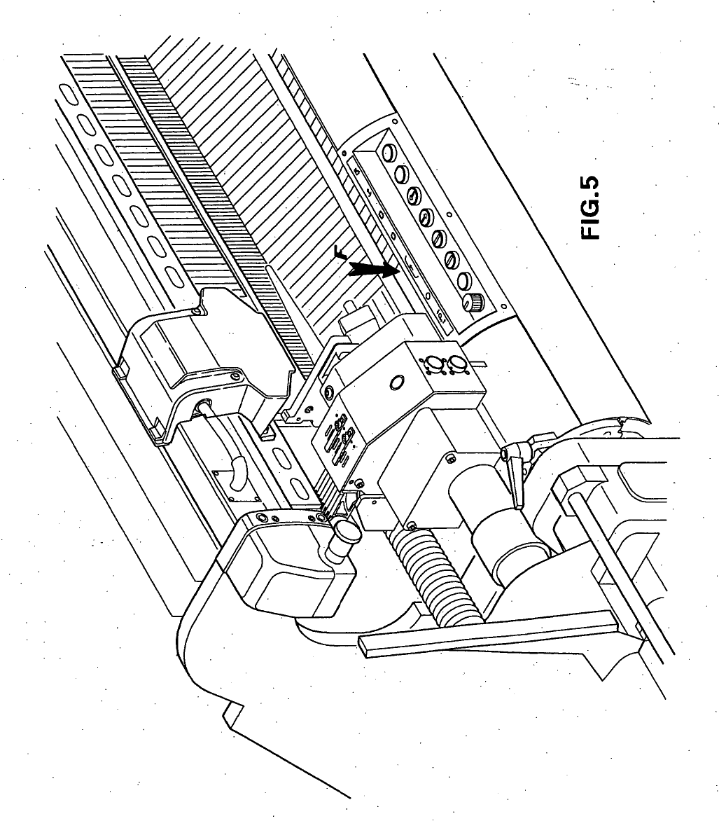

FIG. 5 is a discontinued perspective view of an exemplary weaving loom, showing the position thereon of the device of the invention.

The device according to the present invention comprises a housing elongated cup 1, into which are positioned—along the direction of an optical path—a plate with a sensing element 2, a set of focusing lenses 3, a reflecting mirror 4, and a window 5 to define a focal plane.

The elongated cup 1 is closed at the top by a cover (not shown) having a single opening into which is set the focal plane window 5. The elongated cup is meant to be mounted on the fabric holder of a weaving loom, under the fabric being woven which moves adhering to the cover and to the focal plane window 5. For example—though not illustrated—the device according to the invention is installed in the position indicated by the arrow F in FIG. 5.

Consequently, the portion of fabric moving over the window 5, if suitably lighted, is acquired by the sensing element 2 positioned at the opposite end of the optical path illustrated in FIG. 3. For this purpose, lighting means are further provided, which suitably light up the fabric in correspondence of the focal plane P_{f}.

Preferably, the lighting means are positioned inside the elongated cup 1 (namely beneath the fabric), whereby they allow to acquire the image of the fabric by reflection. The lighting means consist for example of a set of eight LED (light emitting diodes) 6, fixed into a frame 7 positioned under the window 5 and above the mirror 4.

The LED are for example of the Kingbright®L54PWW type, with white light.

The LED are preferably arranged so as to converge towards one another (see FIG. 3) and determine the highest lighting intensity on the focal plane P_{f}.

The luminous beam reflected by the fabric is rotated by 90° by the mirror 4 and directed longitudinally to the elongated cup 1 through the set of lenses 3, which provides to focus it onto the sensing element 2 of the plate.

The sensing element 2 is of the CCD type and is apt to acquire the luminous beam at preset sampling intervals and convert it—in a known manner per se—into analog or, preferably, digital signals.

The sensing element 2 can be a bidimensional array or, preferably, a linear array: in this last case, the various image lines scanned over time get to form the lines of a rectangular matrix, which is then available for processing with suitable mathematical algorithms in order to obtain the required information, as described hereinafter.

The plate with sensing element 2 is then connected, by way of conductors 2a, to an overlying printed circuit 8 housed horizontalwise in the upper part of the elongated cup 1, which includes a circuitry apt to process the signal output by the CCD and to supply a digital signal for subsequent processing by a microprocessor (not shown). Preferably, the conductors 2a are of fixed length—for example in the form of conventional pins for microchips—whereby the plate with sensing element 2 and the printed circuit 8 are fixedly connected each other.

According to a preferred embodiment of the invention, the elongated cup 1 comprises on the inner opposite lateral sides, connecting blocks 1a, 1b and 1c, provided with means for fastening the aforedescribed components.

In particular, the middle block 1b comprises a plurality of vertical slits (not shown): accordingly the plate with sensing element 2 has a thickness allowing it to be inserted with its lateral edges into such slits. In this way it is possible to insert said plate from the top, causing it to slide into the two selected opposite slits, and block it therein applying the top cover of the elongated cup 1.

Likewise, the other two blocks 1a and 1c comprise a set of aligned threaded holes, into which are meant to be screwed fastening screws to block the overlying printed circuit 8.

This mounting method allows to easily shift the plate—and thus the sensing element 2 apt to acquire the image—together with its printed circuit, into a plurality of preset positions in the elongated cup 1, and to thus adapt the focal length to the current conditions.

Likewise, the set of lenses 3, mounted in a cylindrical arrangement, is positioned onto a lower saddle 3a formed integrally with the cup 1, whereon it can be blocked by way of an upper staple 3b apt to be screwed on the saddle 3a in various positions. With this configuration, also the set of lenses 3 can be blocked in various longitudinal positions along the cup 1, so as to adapt the optical path to the current conditions.

These possibilities of adjustment allow not only to correctly focus the image of the fabric lying over the window 5, but also to modify the magnifying ratio (“zoom” function), so as to be able to include in the image acquired by the sensing element a desired number of weft yarns and warp yarns of the fabric being woven, also upon changing of the fabric pattern.

At each change of article on the loom it is hence possible, if desired, to open the cover of the container 1, to shift the plate with sensing element 2 (together with the printed circuit 8) into the wanted slit, to move (or even eliminate) the set of lenses 3—thereby obtaining the desired length of the optical path—and to finally close again the cover of the elongated cup 1.

In operation, the images acquired over time by the device according to the invention can be used for various purposes. A particularly advantageous use of such images is for the quality control of the woven product.

The method used for said quality control provides for the various digital images acquired over time to be compared one to the other, or to a sample image, so as to then determine statistical functions apt to provide an index of the fabric quality. In the event that said function should differ from any preset design parameters, a warning or loom stopping signal is issued, which invites the operator to check whether any problems have arisen in the weaving process.

Likewise, the digital comparison of the images allows to obtain status curves apt to be displayed in real time on an appropriate display screen: by examining how said status curve changes upon varying of the loom working parameters (for example, speed of the main motor, ratio between the speed of the unwinding roller and that of the take-up roller, and so on), the operator can establish the optimal weaving condition for the specific product.

Other methods can be used to process the data supplied by the device according to the invention, but it is not deemed appropriate to describe them in detail herein, since any further inventive contents of these methods form the object of a separate patent application.

The device according to the invention fully achieves the objects set forth above, in that it can be installed on the fabric holder of the loom without interfering with any other weaving members and, at the same time, it allows to acquire an image of a fabric portion as it is being woven.

According to a preferred embodiment, the system to light up the fabric—for example the LED 6—involves an intermittent working, preferably with a frequency adjustable by the operator, or automatically, on the basis of the loom working parameters.

Advantageously, the oscillation of the lighting radiation is in phase with the main motion of the loom.

This stroboscopic effect allows to acquire/sample fabric images of improved quality, that is, with no blurrings or imprecisions determined by the movement of the fabric over the focal plane window 5. In other words, by suitably selecting the operation frequency of the lighting system it is possible to eliminate the harmful influence of the vibrations of the fabric on the acquired images.

It is anyhow understood that the invention is not limited to the particular embodiment described heretofore, which merely forms a non-limiting example of its scope, but that a number of variants can be introduced, all within reach of a person skilled in the art, without thereby departing from the scope of the present invention.

For example, the connection blocks provided with slits can be replaced by other adjustable means to block the sensing element and the set of lenses. All the components may be further adjustable in position by suitable motor means apt to be controlled through wiring from outside of the lid.

Moreover, the emission spectrum of the lighting means—and, proportionally, of the CCD sensitivity—need not necessarily correspond to that of visible light, as it can also be different and possibly chosen according to the type of article being woven.

1) Device to acquire images of a fabric being woven on a loom, characterized in that it comprises at least one window (5) defining a visual field, the fabric being woven moving progressively adjacent to said window, and a sensing element (2) to acquire the image of the fabric, such components being positioned at the opposite ends of an optical path, the length of which is adjustable.

2) Device as in claim 1), comprising moreover a set of lenses (3) along said optical path.

3) Device as in claim 1), wherein said fabric image is acquired by reflection.

4) Device as in claim 3), further comprising means to light up the fabric, positioned close to said window (5) on the side along which said optical path extends.

5) Device as in claim 4), wherein said lighting means consist of light emitting diodes LED (6), arranged so as to converge on the focusing plane (Pf).

6) Device as in claim 5), wherein said LED (6) are equally distributed over a frame (7) mounted around the perimeter of said window (5).

7) Device as in claim 4), wherein said lighting means (6) have an intermittent working with stroboscopic effect.

8) Device as in claim 7), wherein said intermittent working is in phase with the operating frequency of the loom.

9) Device as in claim 1), wherein a mirror (4) is provided close to said window (5), said mirror (4) being apt to rotate by 90° said optical path.

10) Device as in claim 9), wherein the optical path rotated by 90° by said mirror (4) then extends in the direction of the loom width.

11) Device as in claim 1), wherein said sensing element (2) is mounted on a plate perpendicular to said optical path and connected to a printed circuit (8) including the circuitry apt to process the signal issued by the sensing element (2).

12) Device as in claim 11), wherein said sensing element (2) consists of a CCD.

13) Device as in claim 11), wherein said sensing element (2) comprises a linear scanning array.

14) Device as in claim 1), wherein said window (5) includes a plate transparent to at least part of the wave length spectrum apt to be sensed by said sensing element (2).

15) Device as in claim 1), wherein all the components (2, 3, 4, 5, 6, 7, 8) are housed into an elongated cup (1) apt to be mounted on the fabric holder of the weaving loom.

16) Device as in claim 15), wherein said cup (1) has a substantially flat top cover, into which is formed said window (5)

17) Device as in claim 15), wherein said cup (1) comprises adjustable connecting means to mount in an adjustable position at least some of said components meant to determine the length of said optical path.

18) Device as in claim 17) wherein said sensing element (2) is mounted on a plate perpendicular to said optical path and connected to a printed circuit (8) including the circuitry apt to process the signal issued by the sensing element (2); and
wherein said connecting means consist of blocks (1a, 1b, 1c) mounted on the two opposite sides of the cup (1), comprising a plurality of vertical slits into which can be inserted the opposite edges of said plate carrying the sensing element (2).

19) Method for the quality control of a fabric being woven on a loom, making use of a device as in claim 1, characterized in that a plurality of fabric images is acquired through said window (5), at preset time intervals, and the images thus acquired are compared one to the other in order to obtain a repeatability function to be analysed over time.

20) Method as in claim 19), wherein said images are linear scannings of the fabric.
